(19) United States
(12) Patent Application Publication
(10) Pub. No.: US 2013/0044372 A1
(43) Pub. Date: Feb. 21, 2013

(54) ARRANGEMENT OF COLOR SUB-PIXELS IN AN IMAGE DISPLAY PANEL FOR 2D/3D DISPLAY

(71) Applicant: Allen Kwok-Wah Lo, Hong Kong (CN)

(72) Inventor: Allen Kwok-Wah Lo, Hong Kong (CN)

(73) Assignee: 3DV CO. LTD., Hong Kong (CN)

(21) Appl. No.: 13/586,308

(22) Filed: Aug. 15, 2012

Related U.S. Application Data
(60) Provisional application No. 61/575,361, filed on Aug. 18, 2011.

(51) Int. Cl. G02B 27/22

(52) U.S. Cl. 359/463; 359/462

(57) ABSTRACT

An image display having a plurality of color sub-pixels is disclosed. The present invention provides a method for arranging the color sub-pixels such that in a column of pixels the sub-pixels of the same color do not form a straight sub-column. In other words, a sub-pixel column contains the sub-pixels of two or more different colors. When a parallax separator, such as a lenticular screen, is placed in relationship to the image display to form a 3D display, the longitudinal axis of the lenticules can be substantially parallel to the sub-pixel columns. Since a sub-pixel column contains the sub-pixels of two or more different colors, each view of the 3D display as separated by a lenticule contains the sub-pixels of two or more different colors. As such, the 3D display image will not appear as monochromatic at a certain viewing angle.

### CROSS REFERENCE TO RELATED APPLICATION

This application claims the benefit of U.S. Provisional Application No. 61/575,361, filed Aug. 18, 2011.

### FIELD OF THE INVENTION

The present invention relates to an image display panel and, more specifically, to a display that can be used for 2D and 3D displaying modes.

### BACKGROUND OF THE INVENTION

It is well-known that an image display panel, such as an LCD panel, consists of rows and columns of pixels. As shown in FIG. 1, a display panel 10 has a plurality of pixels 100 arranged in a two-dimensional array as rows and columns. A pixel located in the i^{th} row and in the j^{th} column can be denoted as P(i, j). For example, pixel P(3, 2) is located in the third column and in the second row. Each of the pixels comprises a plurality of color sub-pixels. The number of color sub-pixels can be two, three or more. As shown in FIG. 2, each pixel 100 has three color sub-pixels in red (R), green (G) and blue (B). The arrangement of the color sub-pixels in each pixel is the same, regardless of the location of the pixels. As such, the sub-pixels in any sub-column have the same color. For example, all the color sub-pixels in the sub-columns, 101, 104, . . . , are red, the color sub-pixels in the sub-columns, 102, 105, . . . are green, and the color sub-pixels in the sub-columns, 103, 106, . . . are blue. Thus, any sub-column contains only the sub-pixels of a single color.

### SUMMARY OF THE INVENTION

The first aspect of the present invention is an image display that comprises:

a display panel comprising a plurality of pixels, the pixels arranged in a two dimensional array comprising a plurality of rows and a plurality of columns, wherein each pixel comprises a plurality of color sub-pixels and each column comprises a plurality of sub-columns, wherein the color sub-pixels are arranged such that the color sub-pixels in a row (i+1) are laterally shifted at least by one sub-column as reference to the color sub-pixels in a preceding row (i), wherein i is a positive integer.

In the image display of the present invention, the pixels can be grouped into zones, each zone comprising N sub-columns for accommodating N different views of a composite picture, and a parallax separator screen is disposed on the display panel, the parallax separator screen comprising a plurality of parallax separating units, each unit having a width to accommodate one of the zones, N being a positive integer greater than 1.

In one embodiment of the present invention, the parallax separator screen comprises a lenticular screen and each of the parallax separating units comprises a lenticule disposed substantially on one of the zones.

In another embodiment, the parallax separator screen comprises a parallax barrier and each of the parallax separating units comprises a barrier unit disposed substantially on one of the zones.

In various embodiments, each pixel comprises three color sub-pixels in R, G and B, wherein the color sub-pixels are arranged such that the color sub-pixels in a row (i+1) in column (j) is R, G, B while the color sub-pixels in a row (i) in column (j) is G, R, B and the color sub-pixels in a row (i−1) in column (j) is B, R, G.

The display panel, according to various embodiments of the present invention, can also be viewed as having a plurality of color sub-pixels, arranged in a two dimensional array of sub-pixel rows and sub-pixel columns, each of the color sub-pixels having a color, wherein the color sub-pixels in a sub-pixel column are arranged such that the color of a sub-color pixel is different from the color of an adjacent sub-color pixel.

For example, the color of a sub-pixel located in sub-pixel column (k) and sub-pixel row (i) is the same as the color of a sub-pixel in sub-pixel located in sub-pixel column (k+1) and sub-pixel row (i+1), where i, k are positive integers.

The second aspect of the present invention is a method for use in an image display, comprising:

arranging a plurality of pixels in a display panel in the image display in a two dimensional array comprising a plurality of rows and a plurality of columns,

dividing each pixel into a plurality of color sub-pixels and each column into a plurality of sub-columns,

arranging the color sub-pixels such that the color sub-pixels in a row (i+1) are laterally shifted at least by one sub-column as referenced to the color sub-pixels in a preceding row (i), wherein i is a positive integer.

According to various embodiments of the present invention, the pixels can be grouped into zones, each zone comprising N sub-columns for accommodating N different views of a composite picture; and a parallax separator screen is disposed on the display panel, the parallax separator screen comprising a plurality of parallax separating units, each unit having a width to accommodate one of the zones, N being a positive integer greater than 1.

In one embodiment of the present invention, the parallax separator screen comprises a lenticular screen and each of the parallax separating units comprises a lenticule disposed substantially on one of the zones.

In another embodiment, the parallax separator screen comprises a parallax barrier and each of the parallax separating units comprises a barrier unit disposed substantially on one of the zones.

The present invention will become apparent upon reading the description in conjunction with FIGS. 3-11.

### BRIEF DESCRIPTION OF THE DRAWINGS

FIG. 1 shows a typical image display having a plurality of pixels arranged in rows and columns.

FIG. 2 shows a typical image display wherein each pixel comprises three color sub-pixels arranged in a conventional way.

FIG. 3 shows an image display wherein each pixel comprises three color sub-pixels arranged in a staggered manner, according to one embodiment of the present invention.

FIG. 4 shows an image display wherein the sub-pixels are arranged to accommodate two different views in a 3D picture.

FIG. 5 illustrates a lenticular screen having a plurality of lenticules used as a parallax separator for separating the two different views in a 3D picture.

FIG. 6 illustrates a 3D display having a lenticular screen to separate two different views.

FIG. 6a illustrates how a lenticular can be used to separate different views to be viewed by a viewer.

FIG. 7 shows an image display wherein the sub-pixels are arranged to accommodate three different views in a 3D picture.

FIG. 8 illustrates a lenticular screen having a plurality of lenticules used to separate the different views in a 3D picture.

FIG. 9 illustrates a 3D display having a lenticular screen to separate three different views.

FIG. 10 shows an image display wherein the sub-pixels are arranged to accommodate four different views in a 3D picture.

FIG. 11 illustrates a 3D display having a lenticular screen to separate four different views.

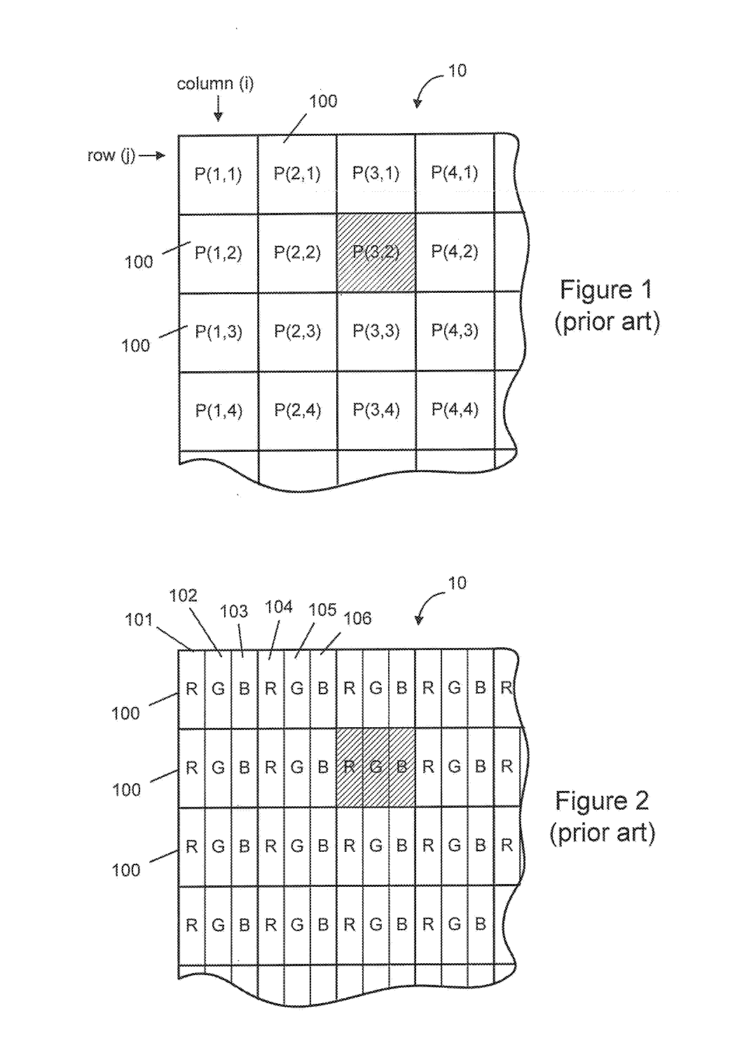

### DETAILED DESCRIPTION

The present invention provides a method for arranging the color sub-pixels in an image display such that in a column of pixels the sub-pixels of the same color do not form a straight sub-column. In other words, in various embodiments of the present invention, a sub-column contains the sub-pixels of two or more different colors. One of the benefits associated with such an arrangement is that, when the image display is used in a 3D display mode together with a parallax separator, the axis of the parallax barriers can be substantially parallel to the pixel columns. In the case where the parallax separator is a lenticular screen and the parallax barriers are lenticules, the lenticules can be placed in relationship to the image display such that the longitudinal axis of the lenticules can be substantially parallel to the pixel columns. Depending upon the width of the lenticules in relationship with that of the sub-pixels, a 3D display image can have two, three or more views. Since a sub-column contains the sub-pixels of two or more different colors, each view of the 3D display as separated by a lenticule contains the sub-pixels of two or more different colors. As such, the 3D display image will not appear as monochromatic at a certain viewing angle.

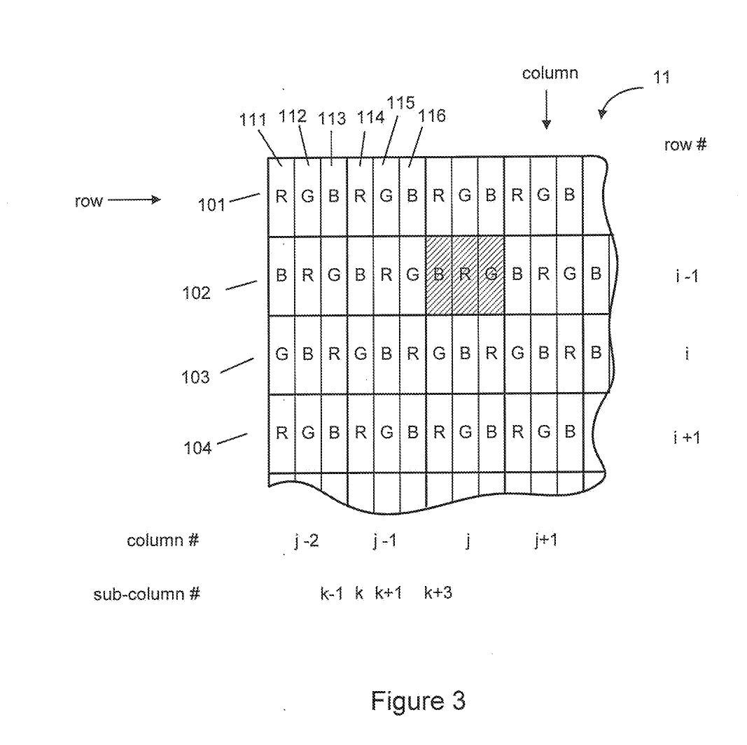

According to one embodiment of the present invention, the arrangement of the color sub-pixels in a pixel dependent upon the row in which the pixel is located. In an image display panel wherein each pixel has three color sub-pixels, the arrangement of color sub-pixels can be carried out in a “staggered” manner as shown in FIG. 3. As shown in FIG. 3, in the image display panel 11, the arrangement of color sub-pixels in each pixel in rows 101, 104, . . . is R,G, B. The arrangement of color sub-pixels in each pixel in rows 102, . . . is B, G, R and that in each pixel in rows 103, . . . is G, B, R. As such, the color sub-pixels in sub-columns 111, 114, . . . are R, G, B, R, . . . , the color sub-pixels in sub-columns 112, 115, . . . are G, B, R, G, . . . and the color sub-pixels in sub-columns 113, 116, . . . are B, R, G, B, . . . As seen in FIG. 3, the color sub-pixels in any row (i+1) are shifted to the right by one sub-column as compared to the color sub-pixels in the preceding row (i). It is understood that the sub-columns can also be shifted to the left by one sub-column. When a pixel has four color sub-pixels, the sub-columns can also be shifted by one sub-column or two sub-columns.

An image display panel, such as display panel 11, wherein the arrangement of color sub-pixels is in a similar “staggered” manner, can be used in displaying a 2D picture or a 3D picture.

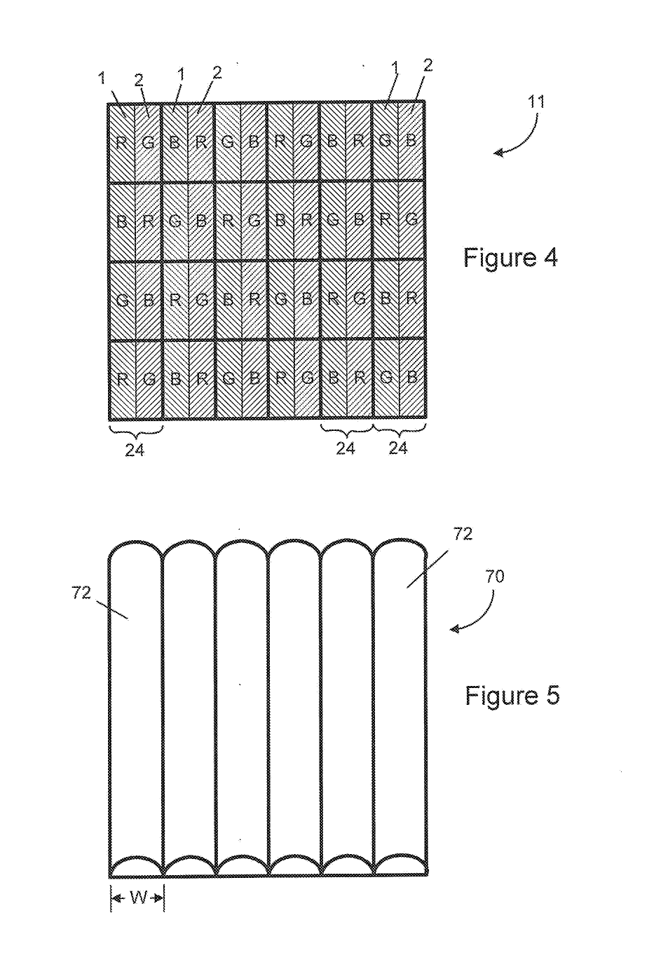

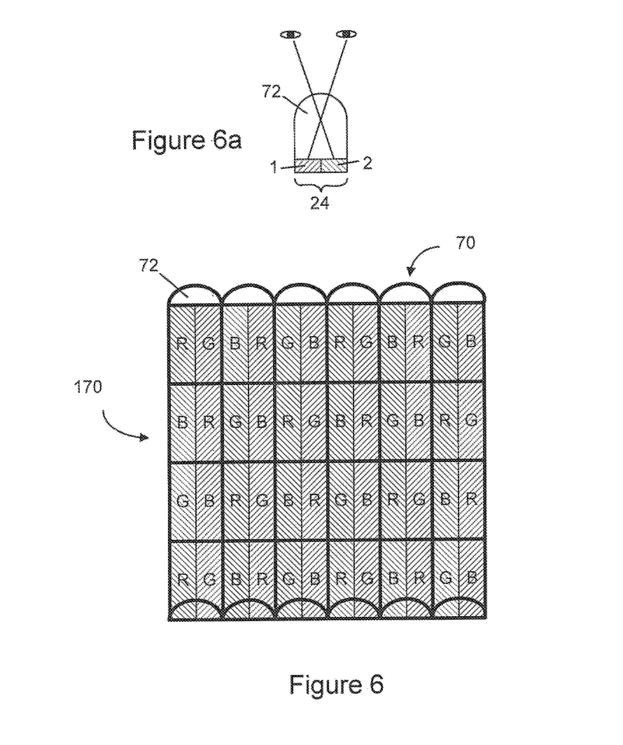

The 3D picture can be composed of two views, three views, four or more views. When a 3D picture is composed of two views, the image display panel 11 can be divided into a plurality of image zones 24, each of the zones 24 has two sub-columns to accommodate views 1 and 2, as shown in FIG. 4. In order to separate the different views to be viewed by a viewer, a lenticular screen 70 having an array of lenticules 72 is disposed over the image display panel 11 to become a composite display 170 as shown in FIG. 6. The lenticules 72 on the lenticular screen 70 have a width W which is substantially equal to the width of the zone 24 in the image display 11 as shown in FIG. 5. The separation of views 1 and 2 by the lenticule 72 is illustrated in FIG. 6a. It should be noted that, a lenticular screen is only one kind of parallax separator. Another kind of parallax separator, such as a parallax barrier screen, can also be used to separate the different views in a 3D picture or display.

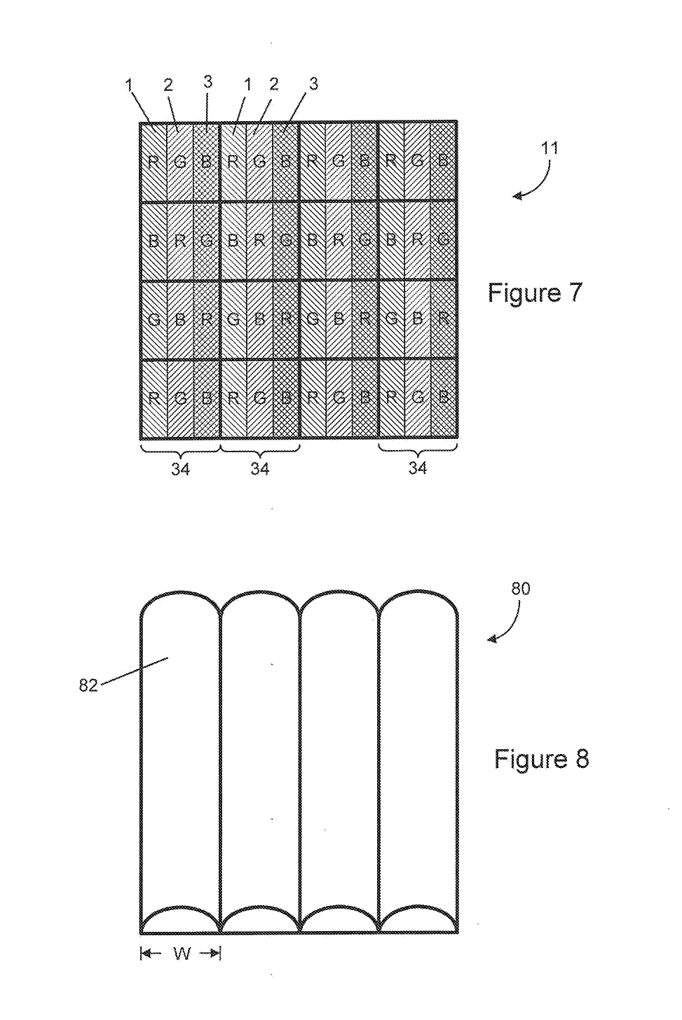

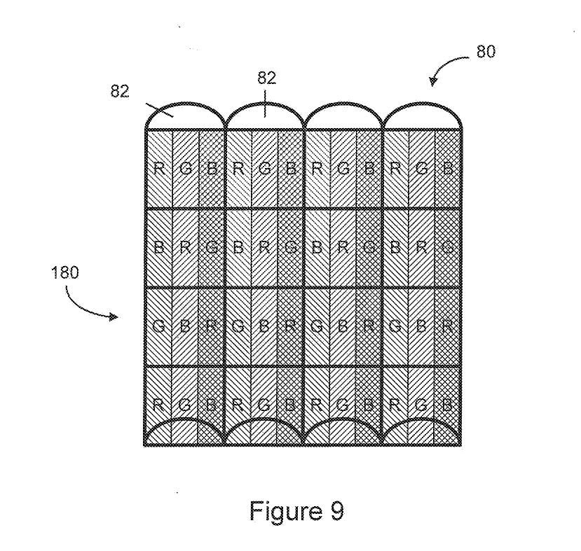

When a 3D picture is composed of three views, the image display panel 11 can be divided into a plurality of image zones 34, each of the zones 34 has three sub-columns to accommodate views 1, 2 and 3, as shown in FIG. 7. In order to separate the different views to be viewed by a viewer, a lenticular screen 80 having an array of lenticules 82 is disposed over the image display panel 11 to become a composite display 180 as shown in FIG. 9. The lenticules 82 on the lenticular screen 80 have a width W which is substantially equal to the width of the zone 34 in the image display 11 as shown in FIG. 8.

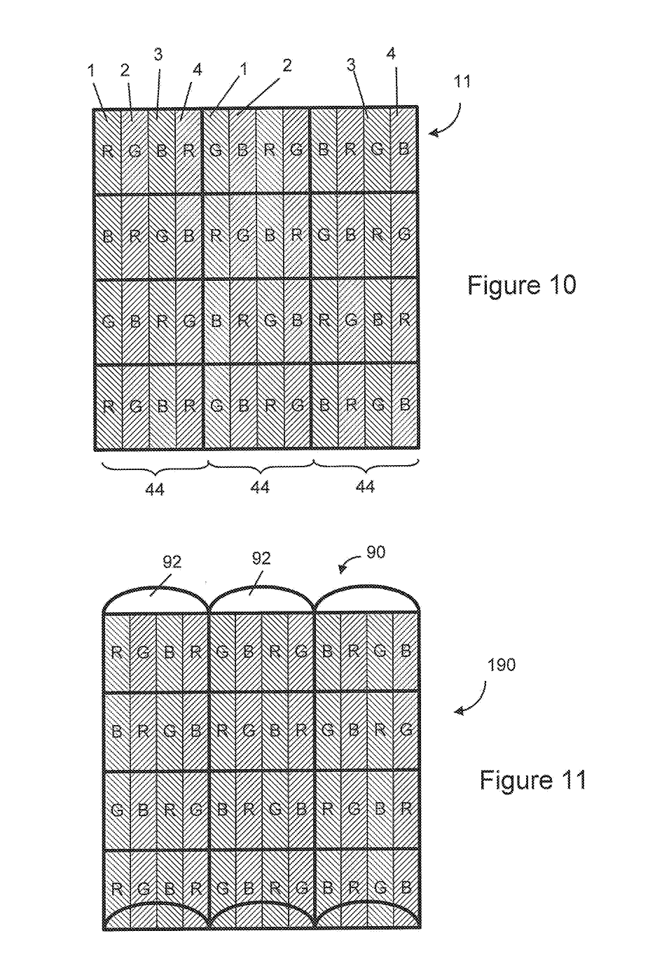

When a 3D picture is composed of four views, the image display panel 11 can be divided into a plurality of image zones 44, each of the zones 44 has four sub-columns to accommodate views 1, 2, 3 and 4, as shown in FIG. 10. In order to separate the different views to be viewed by a viewer, a lenticular screen 90 having an array of lenticules 92 is disposed over the image display panel 11 to become a composite display 190 as shown in FIG. 11.

It should be noted that, the display panel 11 as shown in FIG. 3 can be considered as having a plurality of pixel columns (j−2), j, (j−1), etc., or having a plurality of sub-pixel columns (k−1), k, (k+1), etc. As can be seen in FIG. 3, the display panel 11 has a plurality of color sub-pixels, arranged in a two dimensional array of sub-pixel rows (i−1), i, (i+1), etc. and sub-pixel columns (k−1), k, (k+1), etc., each of the color sub-pixels having a color (R, G or B), wherein the color sub-pixels in a sub-pixel column (k, for example) are arranged such that the color of a sub-color pixel (G in row i) is different from the color of an adjacent sub-color pixel (B in row i−1, or R in row i+1). However, the color of a sub-pixel located in sub-pixel column (k) and sub-pixel row (i) is the same as the color of a sub-pixel in sub-pixel located in sub-pixel column (k+1) and sub-pixel row (i+1).

When the display panel 11 as shown in FIG. 3 is considered as having a plurality of sub-pixel columns to form a composite image composed of three different pictures, then each of the three sub-pixel columns under each lenticule 82 (see FIG. 9) is part of one picture. If the three different pictures are pictures of the same scene taken at three different viewing angles, then the composite display 180 is a 3D display or picture. In such case, each of the three sub-pixel columns is part the 3D picture as viewed at a certain viewing angle. In other words, each of the three sub-pixel columns is part of one of the three different pixtures.

It should be noted that, the present invention has been illustrated as having two different views (FIG. 6), three different views (FIG. 9) and four different views (FIG. 11). It is understood by a person of ordinary skilled in the art that the number of views can vary from 2 to 10 or more. Thus, it can be generalized that the composite image are composed of N different pictures, and each lenticule covers N sub-pixel columns, with N being a positive integer greater than 1.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. An image display, comprising:
a display panel comprising a plurality of pixels, the pixels arranged in a two dimensional array comprising a plurality of rows and a plurality of columns, wherein each pixel comprises a plurality of color sub-pixels and each column comprises a plurality of sub-columns, wherein the color sub-pixels are arranged such that the color sub-pixels in a row (i+1) are laterally shifted at least by one sub-column as reference to the color sub-pixels in a preceding row (i), wherein i is a positive integer.

2. The image display according to claim 1, wherein the pixels are grouped into zones, each zone comprising N sub-columns for accommodating N different views of a composite picture with N being a positive integer greater than 1, said image display further comprising:
a parallax separator screen disposed in relationship to the display panel, the parallax separator screen comprising a plurality of parallax separating units, each unit having a width to accommodate one of the zones.

3. The image display according to claim 2, wherein the parallax separator screen comprises a lenticular screen and each of the parallax separating units comprises a lenticule disposed substantially on one of the zones.

4. The image display according to claim 2, wherein the parallax separator screen comprises a parallax barrier and each of the parallax separating units comprises a barrier unit disposed substantially on one of the zones.

5. The image display according to claim 1, wherein each pixel comprises three color sub-pixels in R, G and B, wherein the color sub-pixels are arranged such that the color sub-pixels in a row (i+1) in column (j) is R, G, B while the color sub-pixels in a row (i) in column (j) is G, R, B and the color sub-pixels in a row (i−1) in column (j) is B, R, G.

6. A method for use in an image display, comprising:
arranging a plurality of pixels in a display panel in the image display in a two dimensional array comprising a plurality of rows and a plurality of columns,
dividing each pixel into a plurality of color sub-pixels and each column into a plurality of sub-columns,
arranging the color sub-pixels such that the color sub-pixels in a row (i+1) are laterally shifted at least by one sub-column as referenced to the color sub-pixels in a preceding row (i), wherein i is a positive integer.

7. The method according to claim 6, further comprising:
grouping the pixels into zones, each zone comprising N sub-columns for accommodating N different views of a composite picture; and
disposing a parallax separator screen on the display panel, the parallax separator screen comprising a plurality of parallax separating units, each unit having a width to accommodate one of the zones.

8. The method according to claim 7, wherein the parallax separator screen comprises a lenticular screen and each of the parallax separating units comprises a lenticule disposed substantially on one of the zones.

9. The method according to claim 7, wherein the parallax separator screen comprises a parallax barrier and each of the parallax separating units comprises a barrier unit disposed substantially on one of the zones.

10. An image display, comprising:
a display panel comprising a plurality of color sub-pixels, arranged in a two dimensional array of sub-pixel rows and sub-pixel columns, each of the color sub-pixels having a color, wherein the color sub-pixels in a sub-pixel column are arranged such that the color of a sub-color pixel is different from the color of an adjacent sub-color pixel.

11. The image display of claim 10, wherein the color of a sub-pixel located in sub-pixel column (k) and sub-pixel row (i) is the same as the color of a sub-pixel in sub-pixel located in sub-pixel column (k+1) and sub-pixel row (i+1), where i, k are positive integers.

12. The image display according to claim 10, further comprising:
a parallax separator screen disposed in relationship to the display panel, the parallax separator screen comprising a plurality of parallax separating units arranged substantially parallel to the sub-pixel columns, each unit having a width substantially equal to N sub-pixel columns, with N being a positive integer greater than 1.

13. The image display according to claim 12, wherein the parallax separator comprises a lenticular screen comprising a plurality of lenticules arranged substantially parallel to the sub-pixel columns, wherein the width of each lenticule is equal to N sub-pixel columns.

14. The image display according to claim 12, wherein each of the N sub-pixel columns is part of a view of a 3D picture.

15. The image display according to claim 12, wherein the two dimensional array of sub-pixel rows and sub-pixel columns comprises a composite image composed of N different pictures, and the parallax separator screen is disposed such that each of the N different pictures can be seen at a different viewing angle.

16. The image display according to claim 15, wherein each of the N sub-pixel columns is part of one of the N different pictures.
